(19) United States
(12) Patent Application Publication
(10) Pub. No.: US 2012/0271844 A1
(43) Pub. Date: Oct. 25, 2012

(54) PROVIDNG RELEVANT INFORMATION FOR A TERM IN A USER MESSAGE

(75) Inventors: John Robert Selbie, Kirkland, WA (US); Lavinder Singh, Redmond, WA (US); Alton Kwok, Redmond, WA (US); Aaron Hoi Lam Mok, Toronto (CA); Ho Wai Poon, Bellevue, WA (US)

(73) Assignee: Microsoft Corporation, Redmond, WA (US)

(21) Appl. No.: 13/090,376

(22) Filed: Apr. 20, 2011

(51) Int. Cl. G06F 17/30

(52) U.S. Cl. 707/769; 707/E17.069

(57) ABSTRACT

One or more techniques and/or systems are disclosed for providing relevant information for a term identified in a user message. A user can read or write a message and one or more terms can be identified in the message, where an identified term may comprise one or more words or characters. One or more data structures comprising indications of temporally recognized terms can be stored locally, and the identified terms can be compared against the locally stored data, such as for fast retrieval. If the identified term matches one or more of the temporally recognized terms in the locally stored data, the user may select the temporally recognized term to perform an action assigned to the temporally recognized term. The assigned action can comprise retrieving relevant information for the term, such as finding movie times (e.g., where the term comprises a movie title).

### BACKGROUND

Users can communicate digitally with contacts using a variety of means. For example, a user may utilize an instant messaging client or application to “chat” with a contact over a connected network (e.g., the Internet), where the conversation may comprise a back and forth of short sentences or phrases. Further, as another example, “texting” can comprise another form of short, back-and-forth conversation with a contact, such as using a mobile phone, a computing device, or a combination of both. Additionally, as another example, the user may create a user message utilizing an email client, and broadcast the message to one or more contacts, one or more of whom may reply instantly, later or not at all. Users may also communicate by posting messages on social networks, such as status updates, direct messaging, micro-blogs, and others, for example. These postings may also be replied to by contacts receiving/reading the user message(s).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Messaging between a user and one or more contacts often comprises terms that may be relevant to an active or ongoing conversation. For example, a user and a contact may be “chatting” about movies, when the user receives a message asking: “do you want to go see the movie ‘X’ tonight, it stars Y?” In this example, the term “X” refers to a movie name, for which show times, theatre locations, and reviews may be relevant to the conversation. Further, the term Y refers to a well-known actor, for which images or news may be relevant to the conversation.

Typically, if the user wishes to find relevant information for a term they enter the term as a query in an online search provider. The search provider can return the relevant information from a query, such as the movie times, locations, and reviews; and/or the actor's images and news. That is, for example, if the user identified an interesting term in the user message they must open a browser, navigate to a search provider, enter the term and perform a search. The information retrieved by the query can then be copied into a user message returned to the contact, for example. Because the user needs to perform the operations outside the context of the user message, the user experience may be diminished, for example, the “chatting” interrupted.

Accordingly, one or more techniques and/or systems are disclosed that provide for retrieving relevant information for temporally recognized terms that may be identified in a user message. For example, while the user is writing or reading a message, such as an instant message (IM), email message, text message, or the like, one or more terms can be identified (e.g., automatically) in the message. The identified terms can correspond to temporally recognized terms, for example, that may be currently (e.g., or from a desired time period) relevant. Further, relevant information for the term can be presented to the user, if desired, for example.

In one embodiment for providing relevant information for a term identified in a user message, the term can be identified in the user message. The identified term can be compared with data that is stored locally, such on a client device accessing the user message, to determine whether the identified term comprises a temporally recognized term. In this embodiment, if it is determined that the identified term comprises a temporally recognized term, and the identified term is selected by the user, an action assigned to the temporally recognized term can be performed, where the action comprises retrieving relevant information.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for providing relevant information for a term identified in a user message.

FIG. 2 is a flow diagram illustrating an example embodiment where one or more portions of one or more techniques described herein may be implemented.

FIGS. 3A and 3B illustrate example embodiments where a bit array may be populated.

FIG. 3C illustrates one embodiment where a term may be looked up in a bit array.

FIG. 4 is a flow diagram illustrating and example embodiment where one or more portions of one or more techniques described herein may be implemented.

FIG. 5 is a flow diagram illustrating an example embodiment where one or more portion of one or more techniques described herein may be implemented.

FIG. 6 is a component diagram illustrating an exemplary system for providing relevant information for a term identified in a user message.

FIG. 7 is a component diagram illustrating an example embodiment where one or more systems described herein may be implemented.

FIG. 8 is an illustration of an exemplary computer-readable medium comprising processor-executable instructions configured to embody one or more of the provisions set forth herein.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for quickly and efficiently finding keywords in a user message, such as one comprising an instant message, and identifying the keywords so that a user may find relevant information for a selected keyword. In this way, for example, a richer user experience can be provided for a user message, such as by allowing the user to select relevant information and add it to the user message (e.g., embedding images, video, and reference information). Further, as an example, the user may be able to identify relevant information associated with a keyword that provides more detail about a particular topic, such as entertainment venues and times, which may be used to provide an improved user experience.

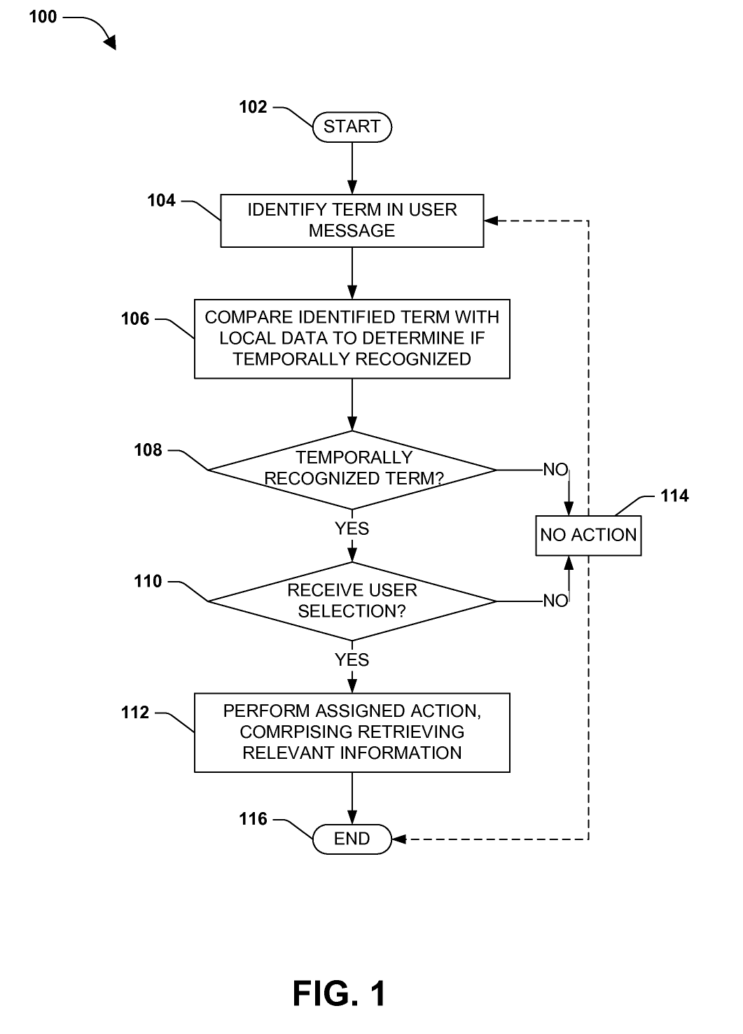

FIG. 1 is a flow diagram illustrating an exemplary method 100 for providing relevant information for a term in a user message. The exemplary method 100 begins at 102 and involves identifying a term in the user message, at 104. For example, the user message may comprise a phrase “Did you see the Seattle Seahawks play?” In this example, the text of the message may be broken down into several different combinations of one to three words, such as “did you see”, “you see the,” “the Seattle,” “Seattle Seahawks,” “Seahawks play,” “did,” “you,” “see,” “the,” “Seattle”, “Seahawks,” and “play”. In one embodiment, the respective combinations of one or more words in the message may be an identified a term. Further, in one embodiment, an identified term may comprise one, two, three or more words and/or characters (e.g., for Asian character-words), for example, depending a desired setting for identifying terms (e.g., a greater number of words may produce more results, but may also result in greater computing resource use).

At 106, the identified term is compared with locally stored data to determine if the identified term comprises a temporally recognized term. In one embodiment, a temporally recognized term can comprise a combination of one or more words that are recognized as having temporal relevance. For example, an online search engine can provide search results for queried terms entered by online users, such as “Seattle Seahawks.” Often, online search providers analyze queried terms entered as searches to identify those queried terms that are “trending,” for example.

A trending term can comprise a query that has an increasing search rate (e.g., more people are searching using the term that previously). In this example, a trending term may be considered temporally relevant at the time it is identified as trending; that is, the term is relevant at that particular time. For example, soon after a large earthquake occurs, the term “earthquake” may likely be a trending term. As another example, search providers can compile a list of the top searched query terms at any particular time, such as identifying a top one hundred current searched terms. In this example, the top one hundred terms may be considered temporally relevant at the time they are identified by the search provider. Identifying temporally relevant terms can help provide an enhanced user experience, for example, where those terms that a user may be interested in (e.g., because they appear to be relevant at the time) are more likely to be identified. Providing stale information, such as for terms that are no longer relevant to users, may lessen the user experience and lead to reduced use of a particular service.

Further, in one embodiment, the data that can help determine whether an identified term is a temporally relevant term can be stored locally, for example, such as on a client device used to access the user message. For example, a user may be instant messaging from their handheld device (e.g., smart phone), and the data used to compare the identified term can be stored in local memory or storage on the hand held device. In this way, for example, the determination process (e.g., comparing the identified term with the locally stored data) may be faster than if the data was stored remotely, such as on a remote server (e.g., at a search service providers server).

In one embodiment, the locally stored data can comprise a data structure used to store an indication of temporally recognized terms. For example, a set of temporally recognized terms, such as query terms retrieved from an online search provider, may be stored in the data structure in a manner that provides for fast comparison with an identified term. Further, in this example, the data structure may be of a desired size so that storage and retrieval resources for the client device are not burdened in a way that lessens the user experience. In one embodiment, the data can be received by the client device, such as over a network connection (e.g., the Internet connected by Wifi, cellular, or some other means) and stored in local storage. Therefore, for example, a data structure comprising a smaller size may reduce bandwidth use during retrieval, and storage resource use on the client device.

At 108 in the exemplary method 100, if the identified term does not comprise a temporally recognized term when compared with the locally stored data (NO), no action is taken at 114. For example, in the user message “Did you see the Seattle Seahawks play?” the identified term “you see” is not likely to comprise a temporally relevant term (e.g., one that is a trending search query tem). In this example, no action is taken with regard to the identified term “you see,” and another term may be identified in the user message, at 104, or the exemplary method may end at 116.

If the identified term does comprise a temporally recognized term when compared with the locally stored data (YES at 108), but an indication of a user selection of the identified term is not received (NO at 110), no action is taken, at 114. For example, in the user message “Did you see the Seattle Seahawks play?” the identified term “Seattle Seahawks” may comprise a temporally relevant term (e.g., online search users may be querying Seattle Seahawks recently to find scores, tickets, or because they played on Monday Night Football, etc., thereby making the term become temporally relevant). However, the user may not select the identified term Seattle Seahawks, for example, as they are not currently interested in seeing information about the Seattle Seahawks, and/or it may not be germane to their current task. In one embodiment, no action is taken with regard to the temporally recognized term “Seattle Seahawks,” and another term may be identified in the user message, at 104, or the exemplary method may end at 116.

If the identified term comprises a temporally recognized term (YES at 108), and an indication of a user selection of the identified term is received (YES at 110), an action assigned to the temporally recognized term is performed, at 112, which comprises retrieving relevant information. In one embodiment, a data structure comprising a set of temporally relevant terms may be assigned an action, for example, which involves retrieving a particular type of relevant information for a member of the set, when selected (e.g., by a user). Accordingly, such an action may be said to be assigned to, associated with, etc. a data structure and/or a term of/from/identified by, etc. the data structure. As an illustrative example, the set of temporally relevant terms stored by the data structure may comprise movie titles, and the assigned action may comprise retrieving theatre locations, and/or show times for the movie. As another example, the set of terms in the data structure may comprise geographic locations, and the assigned action may comprise retrieving a map of the location.

In one embodiment, more than one action may be assigned to a temporally relevant term. For example, a set of temporally relevant terms stored by the data structure may comprise celebrity names, and the actions assigned to the set may comprise: retrieve images, retrieve videos, retrieve music, and/or retrieve news. In one embodiment, a user may be provided with a choice of relevant information that can be retrieved for the temporally relevant term. For example, if more than one action is assigned to the temporally relevant term, as described above, upon selection of the identified term, the use may choose whether to retrieve images, retrieve videos, retrieve music, and/or retrieve news.

Having performed the assigned action, and retrieved the relevant information for the temporally recognized term, the exemplary method 100 ends at 116.

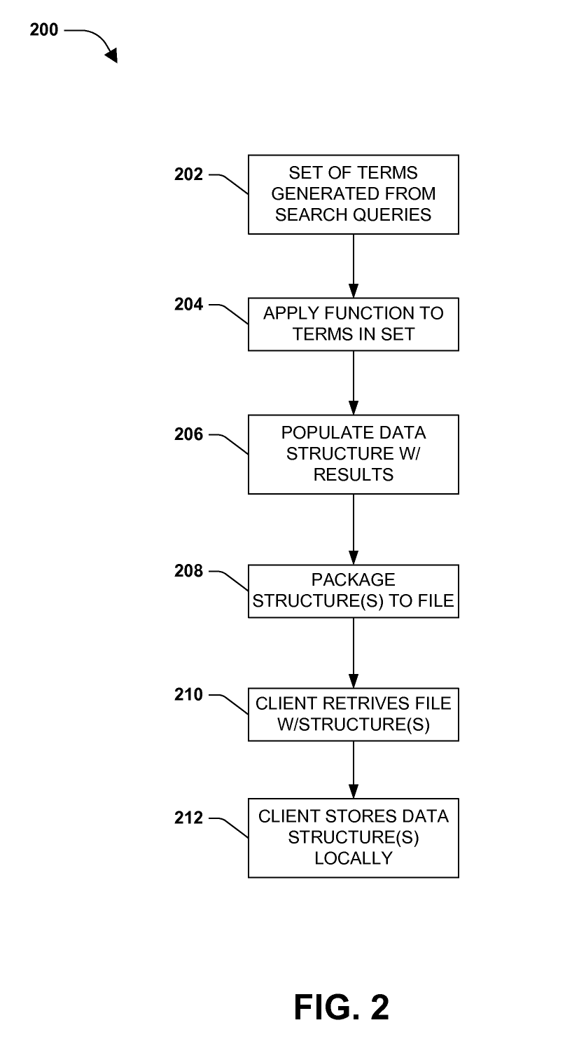

FIG. 2 is a flow diagram illustrating an example embodiment 200 where one or more portions of one or more techniques described herein may be implemented. At 202, a set of temporally recognized terms can be generated from search query terms (but not necessarily search results resulting from performing searches based on these terms), such as entered into a search engine of an online search provider. In one embodiment, a set of temporally recognized terms used to populate a data storage structure (e.g., a bloom filter bit array) can comprise search query terms entered into a search engine from a desired time period, such as the past hour, day, week, etc. In this way, in this embodiment, the set of terms mined from the search engine queries are temporally recognized, such that they are recognized to be relevant to a particular time (e.g., the most recent time period).

As an illustrative example, a set of temporally recognized terms may be respectively collected from search queries comprising movie names (e.g., for movie information, ratings, trailers, theater locations, show times, etc.); queries comprising sports teams and/or athletes (e.g., for game times, scores, ticket info, etc.); queries comprising site and/localities (e.g., travel information, flight deals and details, maps, etc.); queries comprising celebrities names (e.g., for information/news, pictures, videos, music, concert/event information); queries comprising restaurant names (e.g., for information, ratings, menus, maps, etc.); queries comprising product names (for product information/news, ratings, prices, shopping information, etc.); queries comprising event related terms, such as concerts, shows, etc. (e.g., for show information, show times, ticket information, etc.); queries comprising food (e.g., for recipes, ratings, dietary information); queries comprising stock symbols (e.g., for prices, other information, etc.); and/or queries comprising weather related terms (e.g., for forecast information), and many others.

In one embodiment, an empty data structure can be created for storing respective sets of temporally recognized terms derived from search query terms. In one embodiment, the data structure can comprise a bit array that may comprise a small data structure size, while providing a fast an efficient way to compare data. In this way, the data structure may be downloaded to a client device using less bandwidth than other data structures, may have a smaller data storage footprint on the client device, and can provide for fast lookup/comparison of data than other data structures.

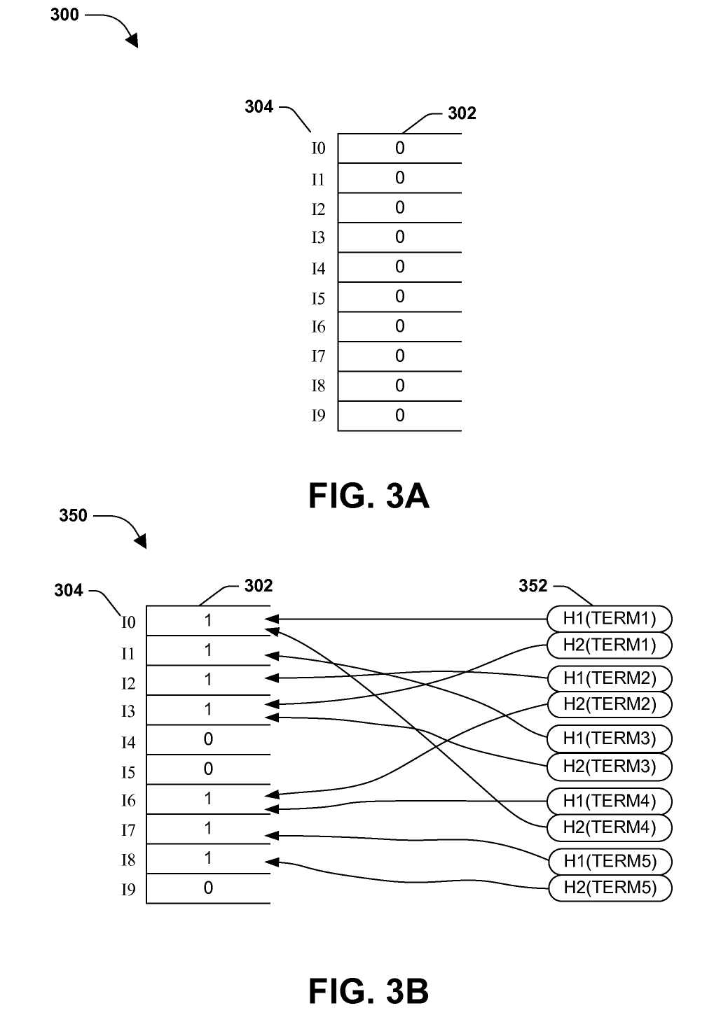

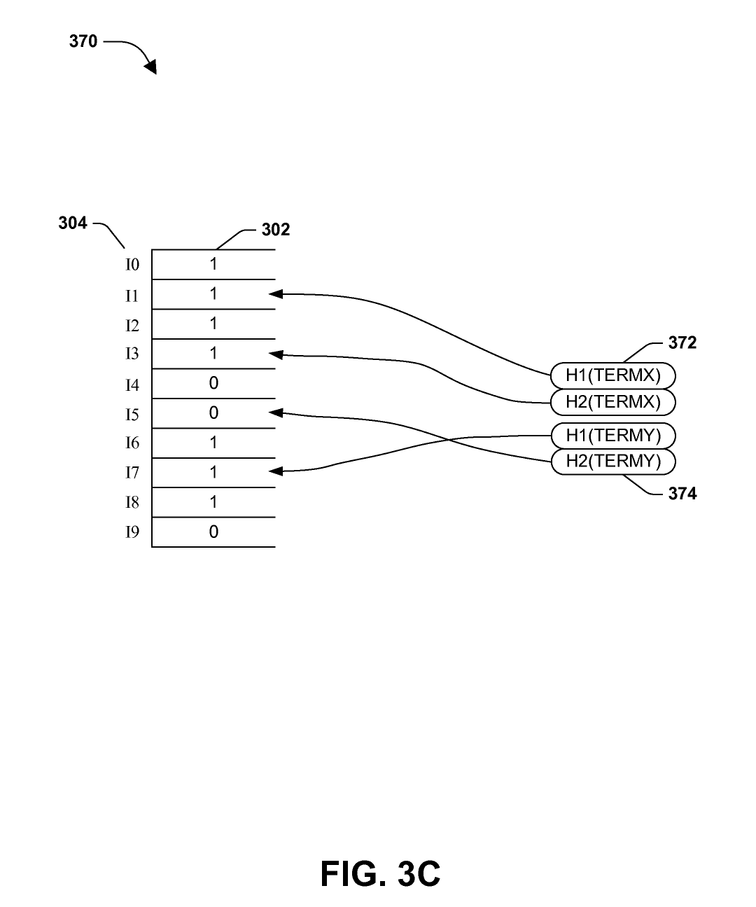

As an illustrative example, FIGS. 3A and 3B illustrate example embodiments 300, 350 where terms may be indexed by a bit array. In the example embodiment 300 of FIG. 3A, a bit array 302 can be created, where respective positions of the bit array 302 are set to zero (e.g., empty, “off”, not-activated). In this example embodiment 300, respective positions of the bit array 302 can be assigned indices 304, such as the ten positions assigned index (I) 0 through index (I) 9.

Returning to FIG. 2, at 204, a function can be applied to the respective terms in the set (e.g., respective terms in respective sets can be hashed). For example, hashing a term can comprise applying a hash function to the term (e.g., inputting the term to a hash algorithm) to yield a resulting hash value. A hash function can comprise an algorithm that outputs a value when a term is used as input. For example, a hash function that assigns a number value to respective characters in the term can sum the character values, divide the sum by two times a number of characters in the term, and round the dividend up to the nearest integer (e.g., h(term)=I). In this example, the resulting output value of the hash algorithm can comprise a “hash value” for the input term (e.g., an index position value).

In one embodiment, the hash value may be used as an index position mapping to a bit array (e.g., an array comprising zeros (off) and/or ones (on)). In one embodiment, a temporally recognized term, from a set of temporally recognized terms, may be hashed (e.g., input to the hash algorithm) using more than one hash functions. In this embodiment, for example, results from respective terms in the set can map to a set of index positions in the bit array for the potential term.

As an illustrative example, in FIG. 3B, the set of temporally recognized terms can comprise terms 1 through 5 (term1 . . . term5), and the bit array can be populated using hash functions one and two (H1, H2), for respective terms. In this example 350, the respective terms in the set can be hashed 352 by hash function one and hash function two, and the result can indicate an index position 304 in the bit array 302. For example, inputting term1 to hash function one H1 can generate an output value of zero (e.g., h1(term1)=0). The zero value can correspond to the index position I0 304 of the bit array 302 for term1. In the index position I0 304 of the bit array 302, the bit value can be changed from 0 to 1, thereby indicating an “on” or “activated” or “occupied” position for the index I0 304 of the bit array 302.

Further, in this example embodiment 350, term1 can be hashed by hash function two H2, resulting in an output value of three. The hash value three can correspond to the index position I3 304 of the bit array 302, where the bit value can be changed from 0 to 1. Additionally, in this example, the respective terms, term2-term5 in the set can be hashed by the hash functions one and two, and the respective results can be mapped to the index positions 304 of the bit array. At the mapped index positions (e.g., I0-I9), the bit value can be selectively changed from zero to one, for example, where a bit value that has already been activated by a first hashing can remain at one if a second hashing indicates the same index position. For example, where the bit value of I0 is changed from zero to one based upon applying hash 1 to term 1, the bit value of I0 can remain one when hash 2 is subsequently applied to term 4 (e.g., and similarly for h2(term1) and h2(term3), and h2(term2) and h1(term4)). In this way, for example, the bit array 302 can comprise indications of the respective temporally recognized terms in the set of terms, such as mined from the search query terms.

Returning to FIG. 2, at 206, the results of the hashing of terms may be used to populate a data structure, such as a bit array, as described above. In one embodiment, a plurality of data structures may be created and populated, respectively, with a set of temporally recognized terms. For example, a first set may comprise movie titles, a second set may comprise celebrity names, a third set may comprise sport team and athlete names, and so on. In this example, respective sets can be used to populate a data structure. At 208, the respective one or more data structures, such as the populated bit arrays, can be packaged into one or more files, such as a file that is configured to be sent over a network connection (e.g., compressed and configured to have respective arrays extracted after receipt).

At 210, a client can receive the file comprising the one or more data structures, and the one or more data structures can be stored locally on the client device. For example, the client may be configured to periodically (e.g., after a desired periodic interval) retrieve (e.g., or request) the file comprising the one or more data structures, respectively comprising a set of temporally recognized terms. In this example, the file can be received by the client device, the respective data structures extracted and stored in local memory, and/or local storage. In this way, when attempting to determine whether an identified term comprises a temporally recognized term, the locally stored data may be consulted for comparison, which may be faster than comparing with data stored in a remote location.

In one embodiment, the one or more data structures, respectively indicating a set of temporally recognized terms, which are comprised in the file received by the client device, may also be associated with one or more assigned actions. For example, as described above, the temporally recognized term in a set may comprise a restaurant name, and the action assigned can comprise “retrieve restaurant ratings, information, and/or maps.” In this embodiment, for example, the one or more data structures packaged into the file to be received by the client device can respectively have one or more actions assigned, such as using metadata tags attached to the data structure.

It will be appreciated that the locally stored data is not limited to the embodiments described above. It is understood that those skilled in the art may devise alternate local data storage techniques and/or systems. For example, the locally stored data may be comprised in a database (e.g., two dimensional or three-dimensional); an indexing array, a hash table, or some other form of data storage structure that provides for efficient downloading of data and efficient comparison of data.

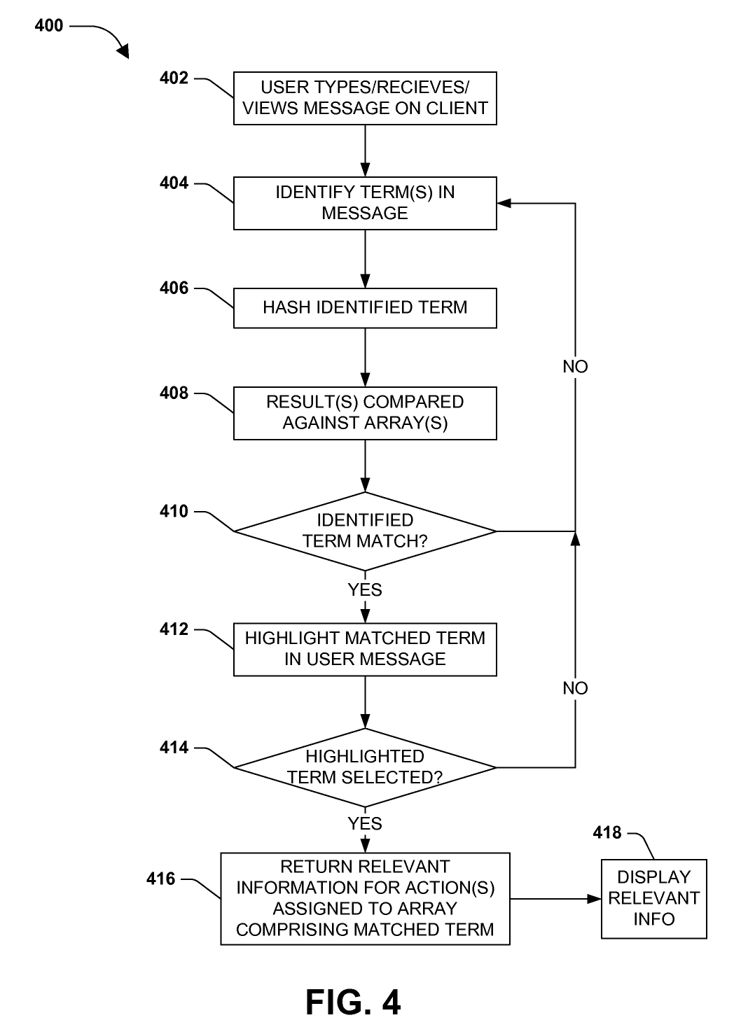

FIG. 4 is a flow diagram illustrating and example embodiment 400 where one or more portions of one or more techniques described herein may be implemented. At 402, a user types, receives, or views a user message on a client device. For example, the user may be chatting with another user utilizing instant messaging, where a first user can type a message, send the message to a second user, who can view the message and respond in kind. In one embodiment, while the first use is composing the message, or viewing a message they are preparing to send or have received from the second user, one or more terms may be identified in the user message, at 404.

As described above, a term can comprise one or more words in the message, of which the length (e.g., number or words and/or characters) may be set by the user, by an application comprising the user message, the client device, and/or a service providing temporally recognized terms, for example. For example, an identified term may comprise one, two, or three (e.g., or more) words in sequence in the user message, and a maximum or minimum number of words (e.g., and/or characters) set for the term identification can have an effect on a type and/or number of temporally recognized terms matching the identified term.

Further, the number of words in sequence used for an identified term may also affect a time and/or resource use to match the identified term with a temporally recognized term. Additionally, when identifying terms in a user message that comprises Asian characters, one or more different settings may be applied to identify terms (e.g., Asian words may comprise one or more characters, and/or may or may not be separated by spaces, etc.).

In one embodiment, to determine whether the identified term comprises a temporally recognized term, a lookup can be performed in one or more locally stored data structures, comprising locally stored data, in an attempt to match the identified term with a temporally recognized term indicated by one or more of the data structures. As an example, at 406 in the example embodiment 400, the lookup can comprise applying one or more hash functions to the identified term. In one embodiment, the identified term may be hashed (e.g., input to the hash algorithm) using a plurality of hash functions. In this embodiment, for example, respective results for the identified term can map to a set of index positions in a bit array.

For example, bit arrays, such as used by bloom filters, can produce a false positive error rate that may be mitigated by using more than one hash function to both populate the bit array with an indication of a set of temporally recognized terms, and to test whether an identified term is a member of the set of temporally recognized terms. Applying more than one hash function (e.g., an optimal number of hash functions) to populate and/or test membership for a set of terms stored by the bit array can provide for improved probability when attempting to determine if an unknown item is a member of the set (e.g., looking up the term in the bit array), for example. An identified term from the user message may be hashed by six hash functions, for example, respectively yielding an output result that may be used to compare with one or more of the bit arrays stored locally.

However, as a number of applied hash functions increases for a bit array, an amount of needed computational resources increase, for example, as well a size of the bit array used to store the members of the set. Therefore, in one embodiment, a number of hash functions used to populate the bit array, and/or determine membership in the bit array, can be identified that may result in a desirable probability and a desirable array size and computation resource use (e.g., based on error tolerance, and/or storage/computation resources available).

At 408, the result of applying the one or more hash functions to the potential term can be looked up in one or more locally stored bit arrays. As an illustrative example, FIG. 3C illustrates one embodiment 370 where a term may be looked up in a bit array. For example, a first identified term (termX) can be hashed 372, using one or more hash functions, hash function one (h1) and hash function two (h2), which were used to populate the bit array 302 (e.g., in 350 of FIG. 3B). The resulting hash values (1 and 3, respectively) for termX may be used to map to corresponding index positions I0 and I3 304, respectively, on the bit array 302. In this example, both the index positions I0 and I3 304 in the bit array 302 comprise a bit value of one (e.g., an “on” position), indicating that these positions in the bit array 302 are mapped by a term in the set of terms. Therefore, in this example, the termX comprises a match to a member of the set of temporally recognized terms stored by the bit array 302.

Alternately, as illustrated in FIG. 3C, a second identified term (termY) can be hashed 374 by the hash functions h1 and h2, respectively. In this example, the resulting output of the h1(termY) 374 comprises a hash value of seven, which maps to the index position I7 304 in the bit array 302. The resulting output of the h2(termY) 374 comprises a hash value of five, which maps to the index position I5 304 in the bit array 302. In this example, while the bit value at index position I7 304 comprises a one (e.g., activated), the bit value at index position I5 304 comprises a zero (e.g., not activated). Therefore, because not all of the bit values are activated for the termY, for example, the termY is not a member of the set of temporally recognized terms comprised by the bit array (e.g., because both index positions would be activated if mapped by the same hash functions when originally populated).

As an example, if the identified term does not match any of the member terms of the set of temporally recognized terms stored by the bit array, the results of the hash function(s) will not match any of the terms indexed by the bit array. As an illustrative example, the set of temporally recognized terms may comprise sports teams, which are respectively indexed to the bit array using one or more hash functions. In this example, if the identified term comprises “Did you,” which may be part of the user message “Did you see the Seattle Seahawks play?”, the identified term may not match any of the terms from the set indexed by the bit array (e.g., when the one or more hash functions are applied to the identified term, and the result(s) are compared against the bit array).

Returning to FIG. 4, if the identified term is not found to comprise a temporally recognized term (e.g., does not match), at 410 (NO), no action is taken for the identified term, and another term may be identified in the user message at 404. If the identified term does comprise a temporally recognized term (e.g., matched), at 410 (YES), the identified term can be highlighted in the user message, at 412. In one embodiment, highlighting the term can comprise changing an appearance of the identified term in the user message such that it stands out to a user viewing the message. For example, additional color may be added to a background of the term, the font color can be changed, the term may be underlined, etc, such that a user can recognize that the term has been identified as a temporally recognized term.

In one embodiment, highlighting the identified term, which comprises the temporally recognized term, can alert the user to select the term, such as to be provided with relevant information about the identified term. As described above, the user may not choose to select the highlighted temporally recognized term in the user message (NO at 414), and no action may be taken. In one embodiment, the highlighted term can remain highlighted, thereby allowing the user to select the term at a later time. Further, additional terms may be identified in the user message, for example, as the user continues to generate, view, receive or otherwise interact with the message.

If an indication of the user selecting the highlighted identified term is received (YES at 414) an action assigned to the temporally recognized term, to which the identified term was matched, can be performed. The action can comprise retrieving relevant information for the temporally relevant term, such as relevant information that may be determined by the assigned action. For example, the assigned action may comprise “retrieve recipe information, ratings, and/or dietary information” for a set of temporally relevant terms comprising food related terminology. In this example, the indentified term may be “artichoke” and the relevant information retrieved may comprise one or more recipes using artichokes, and/or dietary information for artichokes.

In one embodiment, where more than one action is assigned to the temporally recognized term, a choice of relevant information to be retrieved can be provided, for example, so that the user may choose which type of information they wish to view. For example, if the identified term matches a temporally relevant term in more than one data structure (e.g., bit array) respectively comprising a set of temporally relevant terms having different assigned action, a choice of actions, and/or type of relevant information, may be provided.

As an illustrative example, in the user message “Did you see Seattle play Indianapolis last night?” the identified term Seattle may match a temporally recognized term from a set of team names, and from a set of geographic locations. Further, in this example, the assigned action to the set of team names may comprise “retrieve ticket info, scores, game time,” and the assigned action to the set of geographic locations may comprise “retrieve travel info, flight deals, maps.” In this embodiment, for example, the user may be provided with a choice between actions and/or information.

In one embodiment, the relevant information can be retrieved and provided in real-time. For example, the client device may be connected to a network (e.g., the Internet), and upon selection of the highlighted term, the highlighted term can be combined with the assigned action to retrieve the relevant information, such as from an online search provider. At 418, the relevant information can be displayed to the user. In one embodiment, the relevant information may be displayed in a same view as the user message (e.g., inline, in a pop-up in the user message window). In another embodiment, the relevant information may be provided in a separate viewing segment on the client device (e.g., in a separate window, and/or application).

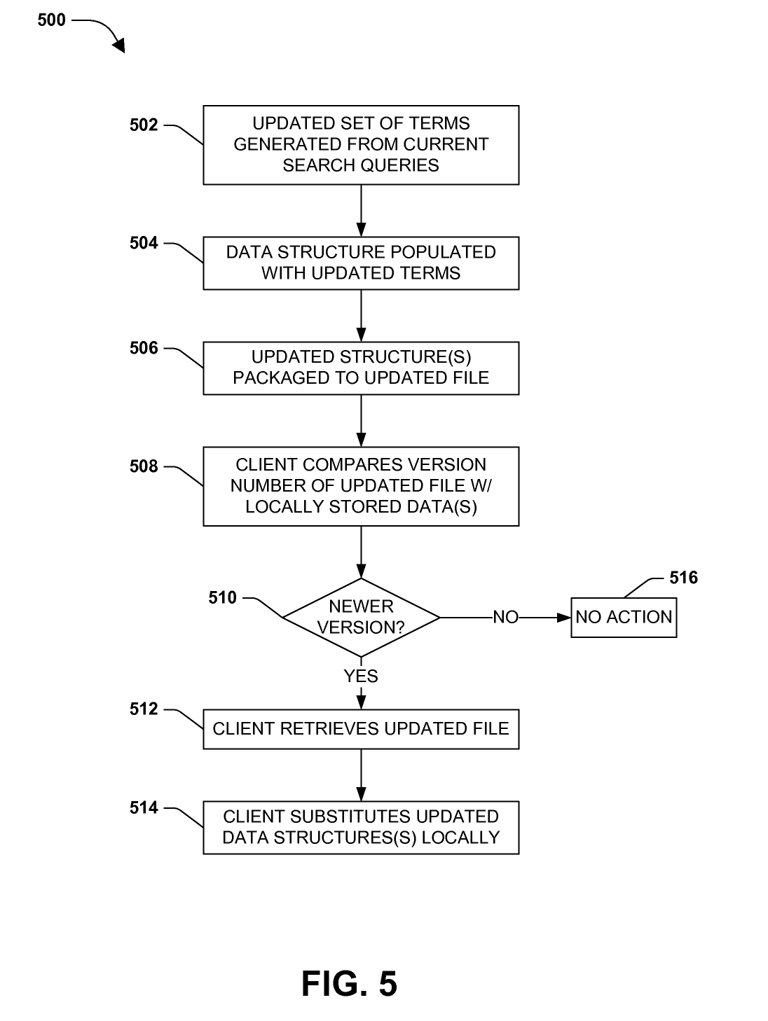

FIG. 5 is a flow diagram illustrating an example embodiment 500 where one or more portion of one or more techniques described herein may be implemented. At 502, an updated set of temporally recognized terms can be generated from current search queries (e.g., of queries from a desired period of time) to a search provider. For example, as described above, a set of temporally relevant terms locally stored by a data structure can comprise search query terms entered by users of a search engine. Further, in this example, search query terms can change over time, such that some terms may become less used (e.g., trending down), while other terms become more used (e.g., trending up).

As an illustrative example, the set of temporally recognized terms used to populate a bit array may comprise a top k number of terms (e.g., top one hundred terms used for queries about movie show times). In this example, as movies are added to and removed from cinemas, the set of temporally recognized terms comprising the query terms can change over time. In one embodiment, the updated set of temporally recognized terms can be generated from an updated set of query terms, for example, from a desired period of time (e.g., updated daily, weekly, etc.). In one embodiment, the updated temporally recognized terms can be mined from updated search data that is temporally relevant (e.g., to the desired time period, such as most recent).

At 504 in the example embodiment 500, one or more updated data structures can be respectively populated with an updated set of temporally recognized terms. For example, a new, empty bit array may be created, and populated with the updated terms comprised in the updated set, such as described above, for example. At 506, one or more updated data structures (e.g., bit arrays) are packaged into one or more updated files (e.g., configured to be sent to a client and unpackaged at the client device).

In one embodiment, the client may access version information for the updated file, such as by navigating to a website comprising the file, receiving notification from a service providing the file, or receiving a request to download the file. In one embodiment, at 508, the client can compare the version of the updated file with the locally stored data to determine if the updated file is actually newer than what is already locally stored. For example, the client may receive a request to update the locally stored data, but may not want to utilize computing resources to download and store the file if it is an older or same version as what is already stored locally.

In one embodiment, the client may receive a request to download the updated file upon initiation of an application accessing the user message, such as a IM client, an email client, a browser, etc.; and/or at an initiation of the client device accessing the user message (e.g., via an operating system). Further, the client may receive a request to download the updated file after a set period of time passing, which may be set by an application and/or user; and/or the user may initiate a request to download the updated file.

If the updated file does not comprise a newer version (NO at 510), no action is taken (e.g., no download), at 516. If the updated file is identified as comprising a newer version than the locally stored data (YES at 510), the client can retrieve the updated file. For example, the updated file may be stored on a remote server, such as comprising a search provider, and the client device can contact to the remote server to download the updated file.

At 514, the client can substitute the locally stored data with updated data, comprising an indication of updated temporally recognized terms. In one embodiment, the updated data can comprise one or more updated bit arrays. Further, if an updated bit array is a newer version, for example, the updated bit array can be stored locally, substituting it for a previous version. For example, a bit array indexing movie titles, which is assigned a “retrieve show times” action, can be substituted with an updated version in local memory (e.g., or storage) if the updated version comprises a newer version (e.g., for more current show times). As another example, a plurality of updated versions of bit arrays may be substituted locally if they respectively comprise newer versions than ones stored locally.

A system may be devised for quickly and efficiently identifying terms in a user message, and providing a way for a user to find relevant information for a selected term. In this way, for example, a user may be provided with additional and/or temporally relevant information while accessing a user message (e.g., reading or writing), and the information can be utilized by the user message to create a richer user message. Further, as an example, the user may be able to quickly find relevant information about a topic identified by a term in the user message (e.g., current images, news, videos, etc.), thereby being provided with more detail that can enhance the user experience.

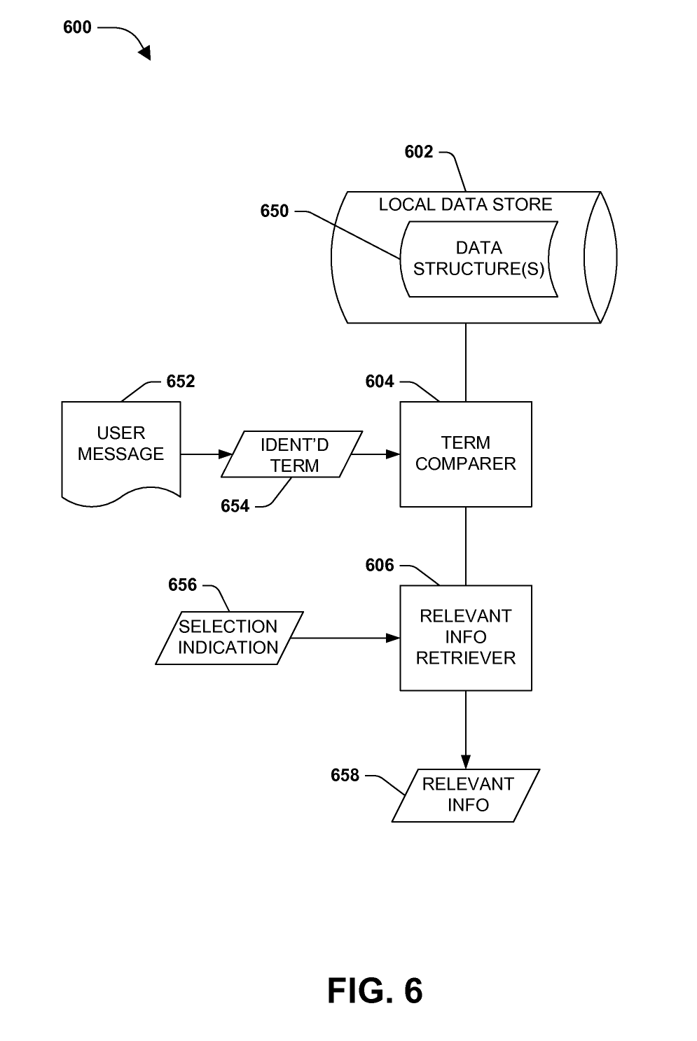

FIG. 6 is a component diagram illustrating an exemplary system 600 for providing relevant information for a term identified in a user message. A local data storage component 602 is configured to store one or more data structures 650 respectively indicating a set of temporally recognized terms. For example, the set of temporally recognized terms can comprise terms that have been mined from queries to an online search provider. The query terms may comprise temporally recognized terms, for example, if they are recognized from a desired time period (e.g., most currently entered query terms for the search provider). A temporally recognized term may be a term that was recently trending upward in online searches, and/or may be a term that is relevant to a particular time period (e.g., one of the top queried terms from the past week).

A term comparison component 604 is operably coupled with the local data storage component 602. The term comparison component 604 is configured to determine if a term identified in a user message 652 comprises a temporally recognized term by looking up the identified term 654 in the one or more data structures 650. For example, the user message 652 can comprise text (e.g., in a variety of languages), and one or more words in sequence from the user message may comprise an identified term. The identified term can be compared with temporally recognized terms, for example, stored in the data structures 650, in the local data storage component 602.

A relevant information retrieval component 606 is operably coupled with the term comparison component 604. If the identified term matches one of the stored temporally recognized terms, and an indication of a user selection 656 of the temporally recognized term is received, the relevant information retrieval component 606 is configured to perform an action assigned to a temporally recognized term. The assigned action comprises retrieving relevant information 658. For example, the relevant information may comprise current and/or more detailed information about the identified term, which can be made available to a user viewing the user message 652.

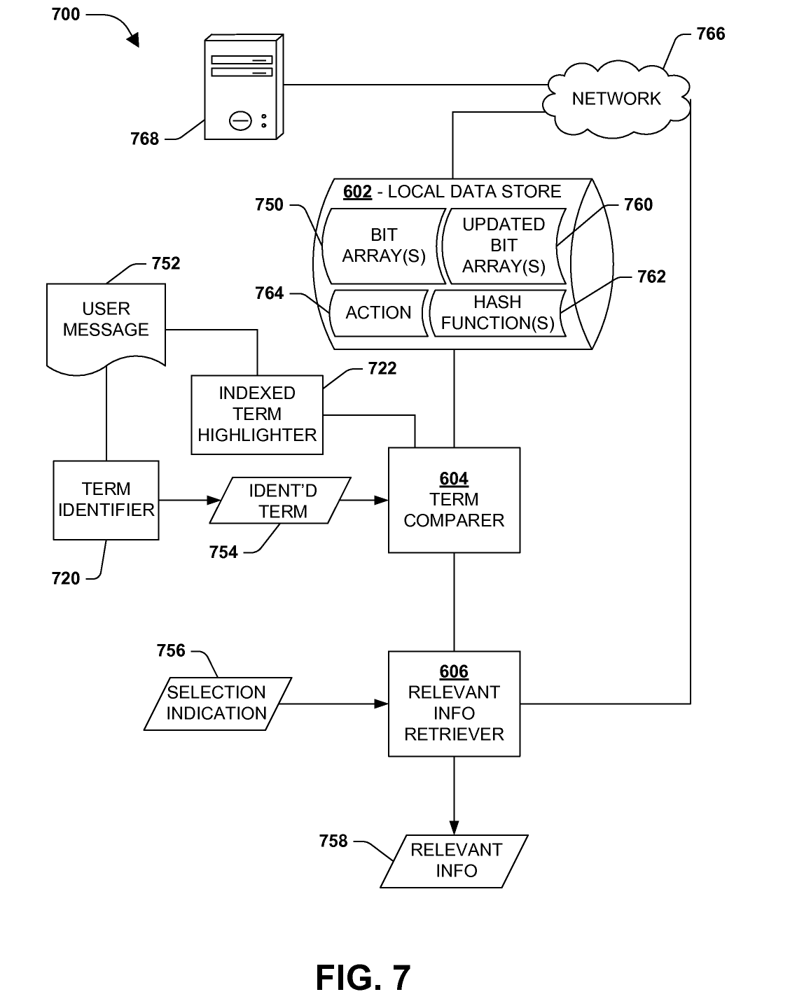

FIG. 7 is a component diagram illustrating an example embodiment 700 where one or more systems described herein may be implemented. In this example, an extension of FIG. 6 is provided and thus description of elements, components, etc. described with respect to FIG. 6 may not be repeated for simplicity. In this example embodiment 700, one or more data structures can comprise a bit array 750 that is populated by using hash functions 762 on respective terms in a set of temporally recognized terms. The set of temporally recognized terms used to populate the bit array 750 can be based, at least in part, upon online search queries from a specified period of time.

For example, an online search provider 768 may collect information on query terms submitted for searches online, such as over a network 766 (e.g., the Internet). The collected information may be mined for information relating to a particular area of interest, such as movie titles, sports teams, locations, celebrities, and more. Further, the queried terms may be related to a particular period of time, such as current period, past day, week, month, etc. In this way, the queried terms are temporally recognized for the period of time from which they are associated. Therefore, the bit arrays 750 can be populated with currently popular query terms, thereby allowing more relevant information to be retrieved.

In this example embodiment 700, the local data storage component 602 can be configured to substitute one or more data structures, such as bit arrays 750, with updated data structures, such as updated bit arrays 760, respectively comprising an indication of updated temporally recognized terms. For example, query terms that were temporally recognized (e.g., popular) for last week can be replaced with temporally recognized (e.g., popular) for the current week, by substituting updated data structures comprising the updated temporally recognized terms.

In the example embodiment 700, a term identification component 720 is configured to identify the term 754 in the user message 752 for use by the term comparison component 604. For example, the term identification component 720 may break the words and/or characters (e.g., Asian characters) into one, two, three (e.g., or more) words or characters, depending on a desired term length setting for the term identification component 720. The respective identified terms 754 can be provided to the term comparison component 604, for example, to determine if they are temporally recognized terms.

A temporally recognized term highlighting component 722 can be configured to highlight the identified term 754 in a user interface (UI) comprising the user message, if the identified term 754 comprises a temporally recognized term. In this way, for example, a user viewing the user message 752 may be made aware that the identified term comprises a temporally relevant term, and may be prompted to select the term, such as by clicking on or hovering over the term, thereby providing a selection indication 756 of the highlighted identified term.

In one embodiment, an action 764 assigned to the temporally recognized term can be based on a type of relevant information 758. In this embodiment, at type of relevant information may comprise: entertainment related information (e.g., movies, shows), popular person related information (e.g., celebrities), dining related information (e.g., restaurants), travel related information (e.g., locations), product related information (e.g., brand names), event related information (e.g., concerts), sports related information (e.g., teams, athletes), financial related information (e.g., stocks), reference related information (e.g., historical figures), weather related information (e.g., forecasts), news related information (current news), and location related information (e.g., points of interest). Further, the relevant information 758, such as retrieved over a network 766 from a search provider 768, can comprise information specific to the action 764, such as movie show times and/or theatre location information for a movie title identified in the user message.

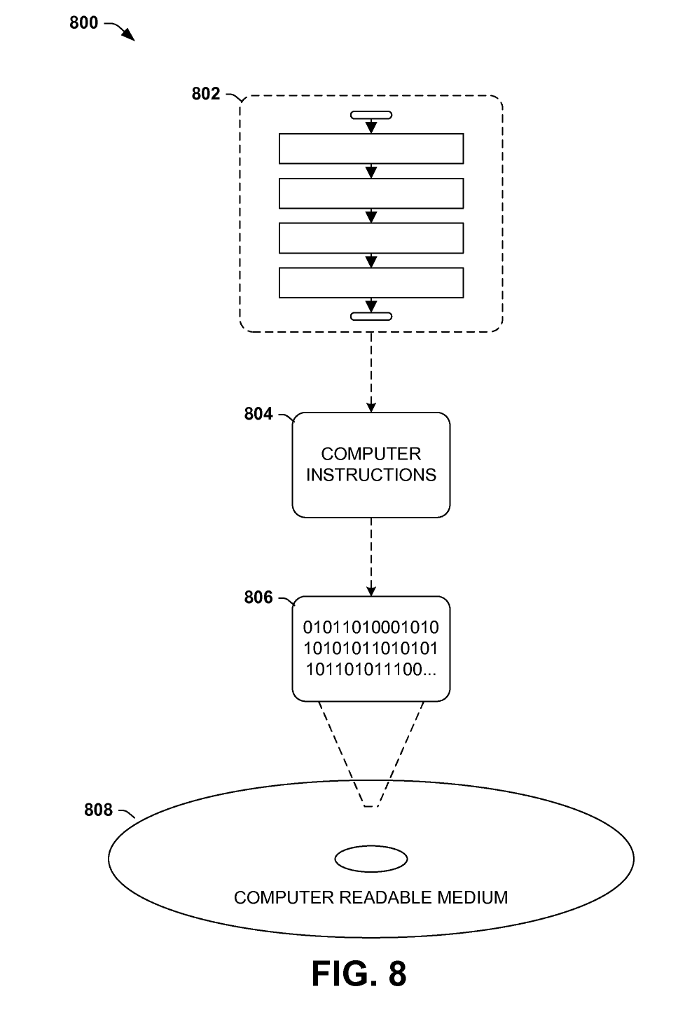

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 808 (e.g., a CD-R, DVD-R, or a platter of a hard disk drive), on which is encoded computer-readable data 806. This computer-readable data 806 in turn comprises a set of computer instructions 804 configured to operate according to one or more of the principles set forth herein. In one such embodiment 802, the processor-executable instructions 804 may be configured to perform a method, such as at least some of the exemplary method 100 of FIG. 1, for example. In another such embodiment, the processor-executable instructions 804 may be configured to implement a system, such as at least some of the exemplary system 600 of FIG. 6, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

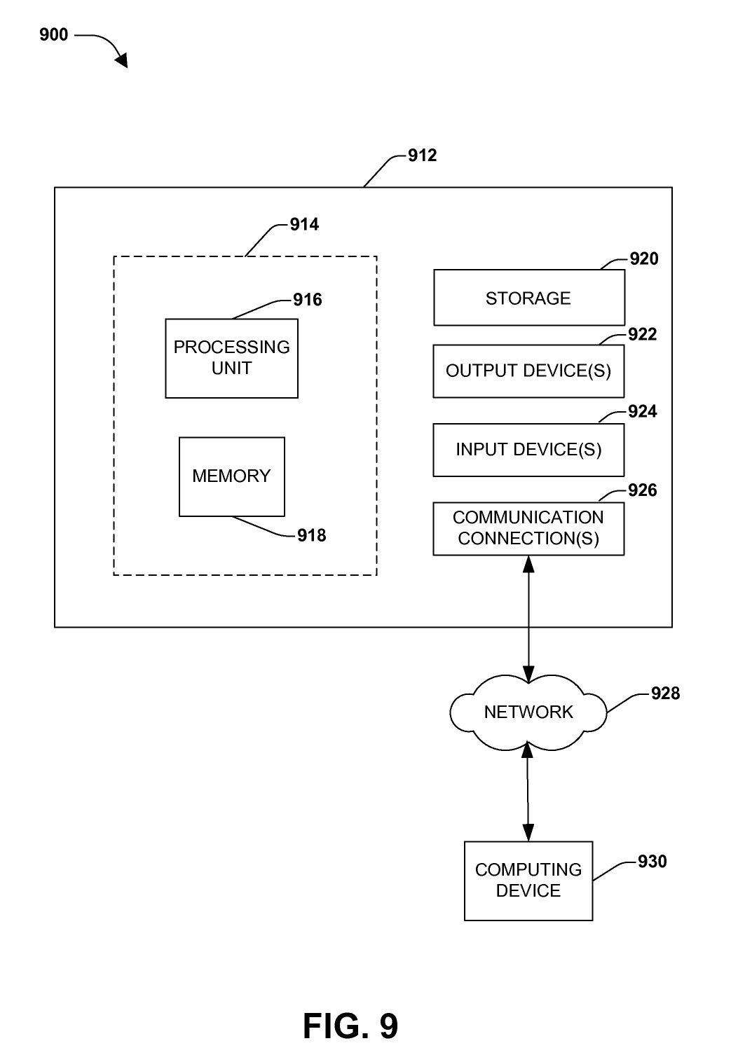

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for providing relevant information for a term identified in a user message, comprising:
identifying the term in the user message,
determining if the identified term comprises a temporally recognized term by comparing the identified term with locally stored data; and
if the identified term comprises a temporally recognized term, and an indication of a user selection of the identified term is received, performing an action assigned to the temporally recognized term, comprising retrieving relevant information.

2. The method of claim 1, comprising locally storing a data structure that is used to determine if the identified term is a member of a set of temporally recognized terms.

3. The method of claim 2, locally storing the data structure comprising locally storing at least one bit array on a client device that is used to access the user message.

4. The method of claim 3, comprising receiving a file at the client device comprising one or more data structures, the one or more data structures respectively:
indicating a set of temporally recognized terms; and
associated with one or more assigned actions.

5. The method of claim 2, comprising receiving a file, comprising one or more updated data structures, upon one or more of:
initiation of an application accessing the user message;
initiation of a client device accessing the user message;
a desired periodic interval passing; and
at an initiation of a user.

6. The method of claim 1, comprising substituting at least some of the locally stored data with updated data comprising an indication of updated temporally recognized terms.

7. The method of claim 6, substituting the locally stored data comprising receiving a file, comprising one or more updated bit arrays, the one or more updated bit arrays comprising an indication of recognized terms mined from updated temporally relevant search data, the indication of updated temporally recognized terms based at least in part on the indication of recognized terms mined from updated temporally relevant search data.

8. The method of claim 1, determining if the identified term comprises a temporally recognized term comprising performing a lookup of the identified term in one or more locally stored data structures comprising the locally stored data.

9. The method of claim 8, performing a lookup comprising:
hashing the identified term, using one or more hash functions used to populate a bit array comprising at least one of the one or more locally stored data structures; and
determining if the identified term is a member of a set of temporally recognized terms identified by the bit array using respective results of one or more hashings of the identified term.

10. The method of claim 1, comprising highlighting the identified term in the user message if the identified term comprises a temporally recognized term.

11. The method of claim 10, receiving an indication of a user selection comprising receiving an indication that the user has selected the highlighted term.

12. The method of claim 1, comprising providing a choice of relevant information to be retrieved if more than one action is assigned to the temporally recognized term.

13. The method of claim 1, comprising providing the relevant information in real-time.

14. A system for providing relevant information for a term identified in a user message, comprising:
a local data storage component configured to store one or more data structures respectively indicating a set of temporally recognized terms;
a term comparison component, operably coupled with the local data storage component, and configured to determine if the term identified in the user message comprises a temporally recognized term by looking up the identified term in the one or more data structures; and
a relevant information retrieval component, operably coupled with the term comparison component, and configured to perform an action assigned to a temporally recognized term, comprising retrieving relevant information, if the identified term is determined to comprise the temporally recognized term and if an indication of a user selection of the temporally recognized term is received.

15. The system of claim 14, the one or more data structures comprising one or more bit arrays populated by using one or more hash functions on respective terms in a set of temporally recognized terms, the set of temporally recognized terms based at least in part upon online search queries from a specified period of time.

16. The system of claim 14, the local data storage component configured to substitute one or more data structures with one or more updated data structures, comprising respective indications of updated temporally recognized terms.

17. The system of claim 14, the action assigned to the temporally recognized term based on a type of relevant information, comprising one or more of:
entertainment related information;
popular person related information;
dining related information;
travel related information;
product related information;
event related information;
sports related information;
financial related information;
reference related information;
weather related information;
news related information; and
location related information.

18. The system of claim 14, comprising a term identification component configured to identify the term in the user message for use by the term comparison component.

19. The system of claim 14, comprising a temporally recognized term highlighting component configured to highlight the identified term in a user interface (UI) comprising the user message, if the identified term comprises a temporally recognized term.

20. A computer readable medium comprising computer executable instructions that when executed via a processor on a computer perform a method for providing relevant information for a term identified in a user message, comprising:
locally storing one or more data structures, respectively comprising a bit array associated with an assigned action;
identifying the term in the user message;
determining if the identified term comprises a temporally recognized term using the one or more locally stored data structures;
highlighting the identified term in the user message if the identified term comprises a temporally recognized term;
if a comparison to a bit array provides that the identified term comprises a temporally recognized term, performing an action assigned to the bit array, comprising retrieving relevant information in real-time, if an indication of a user selection of the highlighted identified term is received;
providing a choice of relevant information to be retrieved if more than one action is assigned to the bit array; and
substituting at least some of the one or more data structures with one or more updated data structures, respectively comprising an indication of updated temporally recognized terms.
